(19) United States
(12) Patent Application Publication
(10) Pub. No.: US 2013/0155442 A1
(43) Pub. Date: Jun. 20, 2013

(54) REMOTE MANAGEMENT FOR MULTI-FUNCTION DEVICES

(71) Applicants: KARTHIK KUPPUSWAMY, KALPAKKAM (IN); RAMESH NAGARAJAN, PITTSFORD, NY (US)

(72) Inventors: KARTHIK KUPPUSWAMY, KALPAKKAM (IN); RAMESH NAGARAJAN, PITTSFORD, NY (US)

(73) Assignee: XEROX CORPORATION, NORWALK, CT (US)

(21) Appl. No.: 13/329,352

(22) Filed: Dec. 19, 2011

(51) Int. Cl. G06K 15/02

(52) U.S. Cl. 358/1.14; 358/1.15

(57) ABSTRACT

The present disclosure describe a remote management system for a multi-function device (MFD). The system employs a monitoring module, a cellular interface, and a control. The monitoring module monitors parameters of the multi-function device. The cellular interface provides cellular data connection between the MFD and an administrator or a service centre that is remotely located. In addition, cellular interface offers transfer of monitored information to a remote location, and further receive instructions from a remote location. Moreover, the control module executes the instructions received from the remote location from the remote location.

### TECHNICAL FIELD

The presently disclosed embodiments relate to multi-function devices, and more particularly to management of multi-function devices in a network.

### BACKGROUND

A multi-function device (MFD) incorporates into a single device a number of traditionally separate functionalities, such as printing, copying, scanning, and faxing. To make these functionalities available to multiple users, an MFD is often incorporated in a computing network, allowing users to communicate directly with the device.

MFDs and single function devices (SFD) often require management from time to time. Generally, management includes proactive checks such as monitoring ink levels, state of paper trays, and so on. Further, management also includes troubleshooting faults and paper jams, and servicing worn out parts of the device. Such management is often cumbersome in networked and standalone devices.

Presently, when an MFD requires servicing or troubleshooting management, a user attempts to solve the problem herself, and if she fails, she has to contact a service centre and describe the fault. Often, the user may not be aware of the fault or may not be able to describe the fault efficiently, and so an executive from the service centre has to physically inspect the MFD to ascertain the fault. Further, because the executive does not know the fault beforehand, the executive must bring all spare parts, debugging software, etc., to the site. This process increases MFD downtime significantly. Moreover, because users sometimes forget to proactively check the printer status, issues such as insufficient ink levels or empty paper trays further increase downtime.

Thus, there exists a need for a solution that provides a convenient and manageable way to monitor and service an MFD.

### SUMMARY

The present disclosure provides a remote management system for multi-function device (MFD). The system employs a monitoring module for monitoring one or more parameters of the multi-function device. The system further includes a cellular interface deployed at the MFD, providing cellular data connectivity. The cellular interface transfers monitored information to a remote location, and receives instructions from the remote location. In addition, the system employs a control module configured to execute the instructions received through the cellular interface.

Another embodiment of the present disclosure provides a method for maintaining a multi-function device. The method involves monitoring the multi-function device to identify faults. Next, the method determines whether the fault requires external assistance. If yes, the method communicates the nature of the fault to a service provider using a cellular network. Subsequently, the method receives instructions from the service provider using a cellular network and implements the instructions.

### BRIEF DESCRIPTION OF THE DRAWINGS

FIG. 1 schematically illustrates an environment for communicating with an MFD over a cellular network, through a cellular interface configured on the MFD.

FIG. 2 illustrates a remote management system, configured on a MFD according to an embodiment of the present disclosure.

### DETAILED DESCRIPTION

The following detailed description is made with reference to the figures. Preferred embodiments are described to illustrate the disclosure, not to limit its scope, which is defined by the claims. Those of ordinary skill in the art will recognize a number of equivalent variations in the description that follows.

As used herein, the term “MFD” includes a single device that offers a number of traditionally separate functionalities, such as printing, copying, scanning, and faxing. Further, “mobile device” refers to any device that has a wireless connection with a network or components related to the network. “Mobile device” can also be a landline telephone as long as it can communicate with the MFD remotely. The present disclosure includes mobile users such as cell phones, Smartphones, PDAs, and so on. Moreover, an “address” is any identifying information that allows a device to be accessed on a network, such as an IP address or URL, the URL including both long form (including full protocol information, such as “http://”) or short form, beginning with “www” or only a website name, such as “foobar.com.” A “cellular identification code” is an identifier compatible with location identifiers on cellular telephone networks. An “access code” is an identifier capable of designating a specific device, such as an MFD, on a computer network or local computer system. A “telephone number” is an identifier capable of identifying a device or location on a telephone network of any type, including traditional voice networks, packet-oriented data telephone networks, voice-over-IP networks, or other telephone networks now in service or hereafter developed.

### Overview

Embodiments of the present disclosure describe a remote management system for an MFD. The systems and methods introduced in this disclosure aid users in effectively and efficiently managing networked or single MFDs and SFDs. To this end, the MFD or SFD (for convenience referred to as “MFD” throughout this disclosure) includes a cellular interface providing cellular capabilities to the device. Moreover, specific management modules and software may be added to the MFD. These modules interact with the cellular interface to troubleshoot, service, and proactively check device status, and generate management alerts.

Therefore, using embodiments of the present disclosure, users may receive alerts about current ink levels or paper tray status on their cell phones, be able to contact service centers directly from the MFD, receive patch files or descriptive solution files directly on the MFD, and remotely operate the MFD through their cell phones.

### Exemplary Network

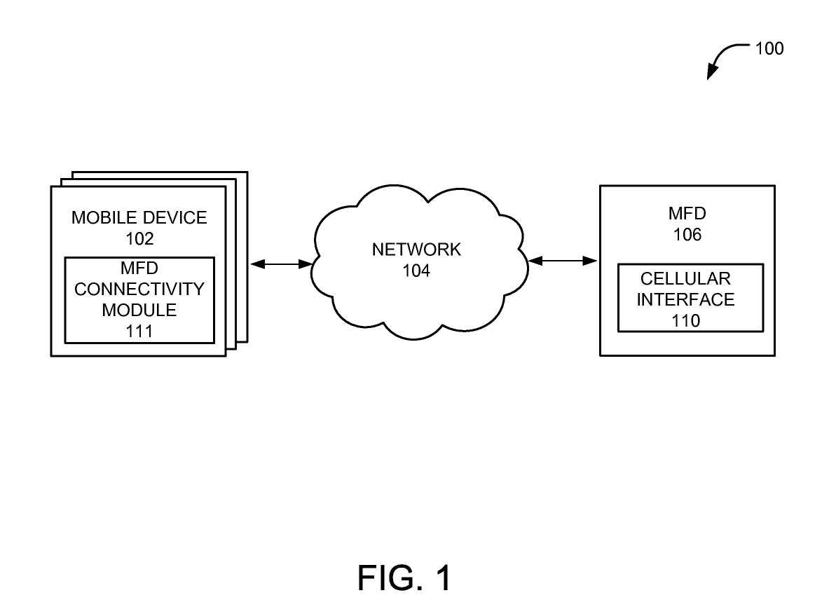

FIG. 1 schematically illustrates an environment 100 in which mobile users can easily communicate with multi-function devices. To analyze the present disclosure, the environment 100 can be visualized as having three primary components, a series of mobile devices 102, a network 104, and one or more MFD's 106. In general, the mobile devices 102 communicate with the network 104 using conventional network protocols, and the network 104 forwards that communication to the MFD 106 over a cellular connection. Communication in the reverse direction may also be carried out using similar protocols.

The mobile device 102 can be any conventional electronic device such as a cell phones, Smartphone, PDA, or landline telephone, used to communicate via the network 104. Generally, a mobile device is any device that communicates with other devices over a cellular network. As shown in FIG. 1, the mobile device 102 is linked to the network 104 via a conventional wireless connection. Such wireless connection means may include wireless gateways, routers, switches, hubs, or cellular base stations.

The network 104 generally refers to a collection of interconnected devices that facilitate communication and sharing of resources and information among the interconnected devices. Further, the network 104 may include all, or a portions of a local area network (LAN), a metropolitan area network (MAN), a wide area network (WAN), or a cellular network. Additionally, the network can be a local, regional, or global communication network such as an enterprise telecommunication network, the Internet, a global mobile communication network, or any combination of similar systems. For example, the network may be an interconnection between an enterprise network, the internet, and a cellular network. When the network is a combination of an enterprise network (or the Internet), and a cellular network, suitable means are employed to seamlessly communicate between the two networks. For instance, a mobile switching gateway may communicate with a computer network gateway to pass data between the two networks. Similarly, if the network 104 includes two or more networks employing differing protocols, suitable interfaces may be introduced to allow communication between these disparate networks.

MFD 106 is a device that performs printing, scanning, copying, or other known imaging functions. It will be understood that the MFD 106 may perform one, few, or all of the mentioned operations without departing from the scope of the present invention. For example, the MFD 106 may be a standalone printer or facsimile machine. Alternatively, the MFD 106 may be a three-in-one printer, scanner, and copier. Further, the MFD 106 may include a suitable interface allowing it to connect with the network 104 and the mobile devices 102. These interfaces include cellular interface, network interface, or parallel to serial interface. In the illustrated embodiment, the MFD 106 includes a cellular interface 110, facilitating cellular connectivity.

Because the MFD 106 has cellular connectivity, using this environment, users on the mobile devices 102 may communicate with the MFDs using the network 104. For example, users may send messages to the MFD 106, or receive messages from the MFD 106.

In addition, mobile device 102 includes an MFD connectivity module 110 that allows the mobile device to communicate with the MFD 106. Although the mobile device 102 and MFD 106 are adapted to send and receive information among each other, the mobile device 102, however, requires an interface that provides compatibility between the two devices. To this end, the MFD connectivity module 110 converts the received information into mobile device format (in case the information is provided by the MFD) and MFD readable format (in case information is sent to the MFD).

For example, if a user wishes to send a print job to the MFD 106 via mobile device 102, the MFD connectivity module 111 may include a print select option. The user simply selects this option and a corresponding instruction is sent to the MFD for processing. Alternatively, when a user receive job status updates from the MFD 106, the MFD connectivity module 111 converts this information into a predetermined format readable by the mobile device. Finally, the status is displayed is a user readable format. In one embodiment of the present disclosure, the MFD connectivity module 111 may be a mobile application installed within the mobile device 102 to provide effective connectivity between the mobile device 102 and the MFD 106.

### Exemplary MFD

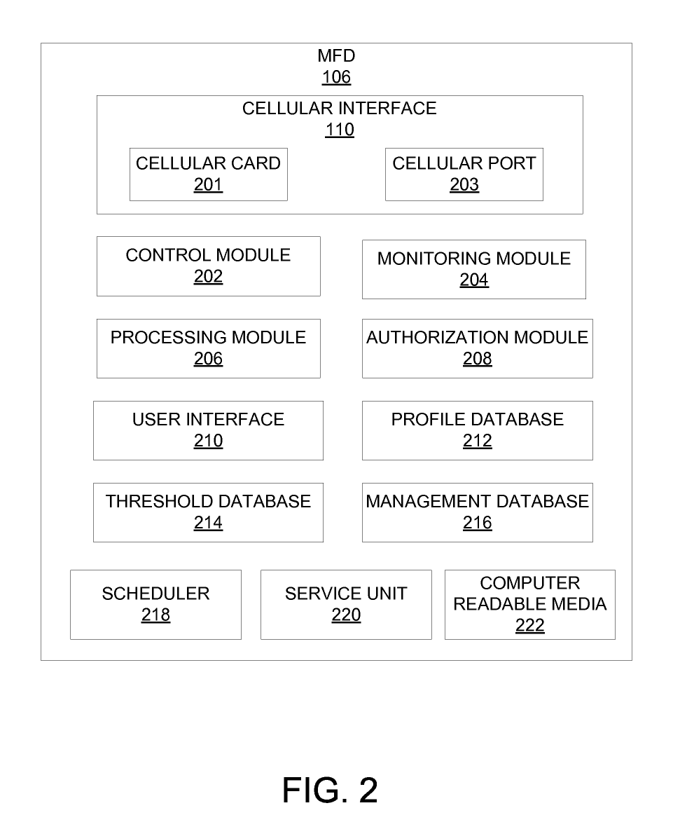

FIG. 2 illustrates a remote management system 200 configured on MFD 106. The MFD 106 may perform various functions including communicating with a remote service center for fault identification, rectification, and servicing; remotely monitoring various parameters associated with the MFD 106; remotely controlling various functions of the MFD 106, such as printing, scanning, selecting print media and so on; and remotely notifying administrators of certain faults in real time.

To be able to perform these functions, the MFD 106 includes cellular interface 110, a control module 202, a monitoring module 204, a processing module 206, an authorization module 208, and a user interface 210. The system further includes one or more databases such as user profile database 212, threshold database 214, and management database 216. Each of these system components will be described in detail in the following sections.

Cellular interface 110 allows the MFD 106 to receive information from other mobile devices 102 and send information to mobile devices 102. To this end, the cellular interface 110 includes a cellular port 201 and a cellular card 203. The cellular card 203 stores, on appropriate storage means (not shown) the telephone number assigned to the MFD 106. Further, the cellular card 203 may employ hardware, software, and firmware, imparting cellular functionality to MFD 106. Additionally, cellular card 203 can employ a cellular modem via which MFD 106 can be accessed. Such cellular components are known to those in the art and thus need not be described in detail here. It is to be appreciated and understood that cellular components need not reside inside MFD 106. Some of the components that impart cellular functionality can be configured externally to MFD 106. The cellular interface 110 may also include a cellular antenna (not shown) to detect cellular signals and transmit information when required.

The cellular interface 110 may include any known cellular technology, such as global system of mobile communication (GSM), code division multiple access (CDMA), wideband CDMA (WCDMA), Time Division Synchronous CDMA (TD-SCDMA), and so on. It will be understood that any known or future developed telecommunication technology may be utilized to provide cellular connectivity to the present day 106. In case of GSM technology, the cellular card 203 may be a Subscriber Identity module (SIM card). A GSM-enabled MFD 106 may communicate with devices in a remote location, such as a cell phone, using voice or SMS services.

It will be understood that because the MFD 106 is connected to a cellular interface 110 it may be moved anywhere in the world. Moreover, configuring the MFD 106 is facilitated by the fact that a telephone number associated with the MFD 106 may remain the same even if the MFD 106 is transferred from one city to another. It should be understood that movement of the MFD 106 may sometimes require a new SIM card for obtaining authorized access to the MFD 106, just as is true for conventional cellular telephones. Based on the new location, a new SIM card may be inserted in the cellular port 201. Details about configuring and gaining access to a mobile MFD is described extensively in co-pending application ______ titled “CELLULAR NETWORK INTERFACE FOR MULTI-FUNCTION DEVICES.” The contents of that application are incorporated here in their entirety.

The control module 202 receives commands, instructions, or information from other mobile devices 102, through the cellular interface 110. For example, the control module 202 may receive a message from a mobile device 102 requesting printer ink level update or requesting a print job. Alternatively, the input module may receive video or text files including instructions from a service center, software updates, or new software to handle certain troubleshooting information. This information may be forwarded to the control module 202 over the cellular network, through cellular interface 110. For example, the service center may send information as data packets using 3G connectivity, such as Short Message Services, and so on. The control module 202 forwards requests and information directly to the monitoring module 204, or the processing module 206. Moreover, if immediate action is not required, the control module 202 may forward the information to an instruction database, which stores the information until required.

Monitoring module 204 monitors the current status of MFD 106 and further assists in remote management. For example, the monitoring module 204 may be configured to monitor multiple MFD parameters, such as usage, toner availability, performance, paper jam, MFD operation mode, job requests, and cartridges. In some instances, the monitoring module 204 may monitor these parameters proactively and in other instances, it may monitor specific parameters based on requests received from the control module 202.

Moreover, the monitored values may be directly provided to the processing module 206 (in case of a request, or a proactive action) or continuously, periodically, or at predetermined times compared with threshold parameter values stored in the threshold database 214. In case of proactive monitoring, the monitoring period and recurrence may depend on the parameter values themselves. For example, toner ink levels may be monitored once a week if the ink level is above 50%, and monitored once a day when the ink level falls below 25%. If the monitored parameter value exceeds or falls below the threshold values (as is the case), the monitoring module 204 may raise a flag and provide the information to the processing module 206. Moreover, for some parameters the threshold database 214 may have multiple thresholds. For example, for number of imaging media present in a printing tray, one threshold may be set at 100 pages, another at 50 pages, and a third at 20 pages.

The processing module 206 receives information from the monitoring module 204 and the control module 202 and provides processed information to the user interface 210, the cellular interface 110 and to one or more of the databases. To this end, the processing module 206 converts the received information into user readable format (in case the information is provided to a user) and database or module readable format (in case information is received from a user).

In case the processing module 206 receives monitored parameter values from the monitoring module 204, it may transmit process the parameter values and convert them into a messaging format and transmit them according to one or more delivery rules. These rules may be preconfigured and reconfigurable for each monitored parameter. Rules may include members in sending lists, message mode, etc. For example, for a particular MFD, messaging lists may be set up such that IT experts are alerted in case of paper jams and housekeeping or administrators are informed when paper levels are low. Moreover, the mode of delivery may also be configured. For instance, the processing module 206 may send SMS alerts to IT experts; generate an audible alert for paper levels; or dial an administrator in case of paper jams.

In case the processing module 206 receives data from the control module 202, it may process that information and act upon it, as required. For example, if the received information is a software patch, the processing module 206 may update the concerned software. Similarly, if the received information is instructions for clearing a paper jam, the processing module 206 may process the instructions and send them to the user interface 210 such that they are easily readable by a human. In another example, the received instructions may be a print command. In this case, the processing module 206 may retrieve the data to be printed and automatically give a print command to the MFD. To perform such varied functions, the processing module 206 maintains unique command codes assigned for various remote services and monitored parameters, such as diagnostics, printer monitoring, controlling, and fault notification. For example, processing module 206 includes a command code corresponding to a paper jam fault. Depending on the communication between MFD 106 and a remotely located device, these codes may be used to process the status identified by the monitoring module 204.

The authorization for module 208 regulates access to the MFD based on predetermined access codes or preconfigured telephone numbers. For example, each cell phone number may have an associated access code, known only to the user. So, along with the print command, users may also be prompted to enter an access code. If the access code matches the telephone number, the command may be executed. If not, then the authorization module 208 may send an alert to the administrator, to an alternate phone number, or to an email address associated with a user. For these functions, the authorization module 208 maintains a user profile database 212 that includes user information, access codes, telephone numbers, preferred printing configurations, preferred paper quality, etc. When a command is received, the dialing telephone number is compared with the existing numbers in the database. If the numbers match, the corresponding user information is transferred to the processing module 206 along with the command. If the numbers do not match, the authorization module 208 may not allow the user to proceed any further. In this manner, a user may not have to configure his or her preferences each time the user prints a document. Simply based on the user's telephone number, the authorization module 208 may transmit the instruction and the preferred configurations to the processing module 206 for action. Alternatively, the telephone number itself may be an access code.

The user interface 210 may receive data from the monitoring module 204, the processing module 206, the authorization module 208, and the databases. The user interface 210 may include multiple modes of communication, for example, it may be a simple display, an interactive touch screen display, an audio system, a combination of a display and audio system or merely a module for transmitted information to the cellular interface 110 for transmission to a mobile device.

In the case of monitoring information, the user interface 210 forwards the monitored information directly to the cellular interface 110 for forwarding to the right users. If instructions are received, the user interface 210 may display the instructions on the display, or relay them over the audio system. Some instructions may require user inputs as well. In such instances, user interface 210 may impart interactive capabilities to the display device, allowing users to provide information through a keypad, a touchpad, or simple operation buttons on the MFD body.

In addition to the listed modules, MFD 106 may include additional modules such as a scheduler 218 and a servicing unit 220. The scheduler 218 maintains an order of job requests to be serviced by MFD 106 using any known job scheduling algorithm. Processing module 206 along with scheduler 218 provides input to a servicing unit 220, instructing it to perform a desired activity, such as printing or copying.

Servicing unit 220 includes mechanisms arranged to selectively apply ink (liquid ink, toner, etc.) to print media (paper, plastic, fabric, etc.), in accordance with print data within a print job. Those skilled in the art will recognize that there are many different types of servicing units available, and that for the purposes of the present discussion, servicing unit 220 can include any of those known types. In addition, MFD 106 includes computer-readable media 222 such as an EEPROM and RAM. Further, computer-readable media 222 can include a hard drive, ROM, or an EEPROM. These media can store information such as configuration information, fonts, templates, printing data, and menu structure information. Computer-readable media may be a disk drive that provides additional storage for printing data, for example, or other information used by MFD 106.

The illustrated MFD 106 can, and typically does include a module that provides a runtime environment in which applications or applets can run or execute. The runtime environment can facilitate the extensibility of MFD 106 by allowing various interfaces to be defined that, in turn, allow applications or applets to interact with MFD 106 in more manners that are robust.

It will be understood that the modules and the databases referred to in the previous sections are not necessarily utilized together in a single MFD. Rather, these modules are merely exemplary of the various modules that may be implemented within an MFD. For example one exemplary module may only include the monitoring module 204 and the processing module 206, while another exemplary MFD may only include the control module 202, the processing module 206, and the authorization module 208. Further, it will be understood that the MFD 106 may include more modules than the ones described in this disclosure without departing from the scope of the present disclosure.

The following sections will describe various exemplary situations and scenarios where embodiments of the system 200, as shown in FIG. 2, may be implemented in the environment 100, as depicted in FIG. 1. It will be understood that these scenarios are merely exemplary and the system 200 may be used in various other applications without departing from the scope of the present disclosure.

### Exemplary MFD Application—Fault Diagnosis

In this example, the administrator detects a fault with the MFD 106, such as a paper jam or replacing a cartridge, that she cannot rectify herself. In this case, the administrator can either directly dial the service center from the MFD 106, or request a call back from the service center, directly on the MFD 106. Features such as speed dial and call request messaging may be utilized. In another embodiment, when the MFD 106 detects the fault, it may display resolution options on the user interface 210, such as resolve manually or request service center support. If the administrator selects the second option, the processing module 206 may automatically connect with the service centre through the cellular interface 110.

Subsequently, the administrator may utilize the MFD 106 as a simple cellular device and have a voice conversation with a service center representative using attached headphones, or microphone and speakers arrangement. In this case, the representative may ask a series of questions to the administrator to determine the problem, and then offer resolution steps to the administrator to try manually. If the administrator is unable to understand the instructions, the representative may forward a resolution video to the MFD 106 through the cellular network. The MFD 106 may process the video and display it on the user interface 210.

Alternatively, the administrator may know the fault, but not the corrective actions to resolve the fault. In such a case, the administrator may interact with an interactive system at the service center by entering a code associated with the fault on the interactive system, and request for instructions to repair the MFD 106. The service center, in this case, may automatically send the video or text files associated with the fault code to the control module 202. The control module 202 forwards these instructions to the processing module 206, which displays them on the user interface 210. By looking at or reading the instruction, the administrator may resolve the fault.

In another embodiment, fault alerts can be communicated to a service centre, directly. For example, the fault may be software glitch. In these cases, the service center may send a software update or patch to the MFD 106 and the processing module 206 may automatically install the patch to rectify the fault.

### Exemplary MFD Application—Remote Monitoring

In this example, a user, IT executive, service center representative, or MFD administrator may request for an update from the MFD 106, or the MFD 106 may proactively send system updates to any of these individuals.

In case the information is requested by an individual, the individual may request an update, such as ink-level status. To this end, the individual may send an SMS to the MFD 106 using a predefined SMS code. The administrator's mobile device 102 may maintain a list of request command codes corresponding to the status of a parameter, such as usage, toner availability, availability of paper in tray, ribbon, and so on. Alternatively, the MFD connectivity module 111 may include a list of functionalities that a user may avail from his remote location. The user may select the desired option, and the MFD connectivity module 111 may convert the selected option to corresponding instructions, which are transferred to the MFD via the network.

At MFD's end, the processing module 206 can maintain a list of response command codes corresponding to various parameters. The MFD 106 receives the code and forwards it to the processing module 206. The processing module 206 determines the required parameter by comparing the received code with the stored parameter codes and forwards this information to the monitoring module 204. This module, in turn, determines the real time status of the requested parameter and forwards this value to the processing module 206 for further action. The processing module 206 then transmits this information to the requesting mobile device through the cellular interface 110 via SMS, MMS, or voice call.

It will be understood that the individual may request a report of all the monitored parameters, a few of the parameters, or just one of the parameters. Moreover, the individual may request this information as and when required without departing from the scope of the present disclosure.

In case the monitoring module 204 proactively delivers status reports to individuals, the monitoring module 204 may compare the status value with a preconfigured threshold value, and when the monitored value exceeds or drops below the threshold value (as may be the case), the monitoring module 204 may raise a flag. The processing module 206 receives this information and forwards it to the concerned individual using the cellular interface 110. To this end, the processing module 206 may maintain a database including information such as type of action to be taken if threshold is crossed, names and phone numbers of individual to inform when a particular parameter threshold is crossed, mode of message delivery, and so on. The information received from the processing module 206 may be converted into user readable format through the MFD connectivity module 111.

Exemplary MFD application—Remote Controlling

In this example, individuals may remotely control the MFD through the cellular interface 110 and cellular network. Here, the individual's mobile device 102 having the MFD connectivity module 111 can maintain a list of request command codes corresponding to the operations of the MFD 106, such as release of print job, change in operational mode, change printing priority, and so on. Processing module 206 may maintain a list of response command codes corresponding to the MFD operations. In one example, the individual, using mobile device 102, can send a SMS including a request command code, requesting for controlling MFD 106, through cellular interface 110, to control module 202. In turn, the MFD 106 may determine the requested operation by comparing the request code with the pre-stored codes. For some requested functions, the MFD 106 may request user authentication. To this end, the processing module 206 engages the authentication module to validate the individual. Once the individual is validated, the processing module 206 may drive the MFD 106 to perform the requested operation.

In certain examples, various authorized users at remote locations may configure MFD settings as desired. A user may send a request to the control module 202 to modify MFD settings, such as paper quality, printing resolution, and so on. In response, the control module 202 may process the request and change the settings.

All the examples explained in the disclosure are not limiting methods. Any person skilled in the art may implement multiple use cases for remote controlling, monitoring and fault notification alerts, given the flexibility provided by GSM enabled MFD 106. However the SMS request/response command code set is required to be unique for each of the respective remote management services.

It will be appreciated that several of the above-disclosed and other features and functions, or alternatives thereof, may be desirably combined into many other different systems or applications. Various presently unforeseen or unanticipated alternatives, modifications, variations, or improvements therein may be subsequently made by those skilled in the art, which are also intended to be encompassed by the following claims.

What is claimed is:

1. A remote management system for a multi-function device, the system comprising:
a monitoring module for monitoring one or more parameters of the multi-function device;
a cellular interface providing cellular capability to the multi-function device, the cellular interface configured to:
transfer monitored information to a remote location; and
receive instructions from the remote location; and
a control module configured to execute the instructions received through the cellular interface.

2. The system of claim 1 further comprising a processing module.

3. The system of claim 1 further comprising a user interface, and a threshold database storing preconfigured threshold values for one or more MFD parameters.

4. The system of claim 1, wherein the cellular interface includes a cellular card and a cellular port.

5. The system of claim 1 further comprising an authorization module to authorize access to the MFD.

6. The system of claim 1, wherein the multi-function device is at least one of a printer, copier, or a scanner.

7. A method for remotely supporting a multi-function device, the method comprising:
receiving a notification from the multi-function device via a cellular network;
determining any responsive action to be taken by the multi-function device; and
communicating a predetermined code associated with the responsive action to the multi-function device via the cellular network.

8. The method of claim 7, wherein the receiving step includes receiving the notification over at least one of:
SMS;
SMS; or video call.

9. The method of claim 7, wherein the predetermined code includes a video demonstration corresponding to the responsive action.

10. A method for maintaining a multi-function device, the method comprising:
monitoring the multi-function device to identify faults;
determining whether the fault requires external assistance;
upon determining that external assistance is required, communicating the nature of the fault to a service provider using a cellular network; and
receiving instructions from the service provider using a cellular network and implementing the instructions.

11. The method of claim 10, wherein the communicating step includes communicating the fault related details over a voice call, SMS, or MMS.

12. The method of claim 10, wherein the instruction includes a video demonstration corresponding to a resolution for the fault.

13. The method of claim 10, wherein the instruction includes an executable instruction.

14. The method of claim 10, wherein the service provider is a cellular network provider.

15. A multi-function device comprising:
a monitoring module for monitoring one or more parameters of the multi-function device;
a cellular interface including a cellular card and a cellular port, the cellular interface adapted to provide cellular capabilities to the multi-function device;
a control module configured to execute instructions received through the cellular interface; and
a processing module adapted to provide data compatibility between the cellular interface, the control module, and the monitoring module, the processing module is configured to:
send one or more monitored parameters to the cellular interface;
receive instructions from the cellular interface; and
transmit commands to the multi-function device for execution, based on the received commands. the control module to execute.

16. The multi-function device of claim 15 further comprising a user interface, and a threshold database storing preconfigured threshold values for one or more MFD parameters.

17. The multi-function device of claim 15, wherein the multi-function device is at least one of a printer, copier, or a scanner.

18. A mobile system for providing connectivity between a mobile device, a multi-function device, and a service provider via a cellular network, the system comprising:
a connectivity module installed in connection with the mobile device, the connectivity module configured to:
communicate with the service provider via the cellular network;
send instructions to the MFD via the cellular network, the instructions being provided in a predetermined format; and
receive information from the MFD.

19. The system of claim 18, wherein the connectivity module sends instructions to the MFD via at least one of:
SMS;
MMS; or
video call.

20. The system of claim 18, wherein the connectivity module receives information from the MFD through an SMS, MMS, or voice call.

21. A system for providing maintenance service to a multi-function device via a cellular network, the system comprising:
a voice communication channel for communicating with a user via a cellular network;
a service communication module configured to:
send instructions to the MFD via the cellular network; and
receive information from the MFD via the cellular network.
